(19) United States
(12) Patent Application Publication
(10) Pub. No.: US 2016/0078519 A1
(43) Pub. Date: Mar. 17, 2016

(54) Method for an LED Product Filtering Engine

(71) Applicants: Adam Green, Boca Raton, FL (US); Eric Gutmann, Boca Raton, FL (US)

(72) Inventors: Adam Green, Boca Raton, FL (US); Eric Gutmann, Boca Raton, FL (US)

(21) Appl. No.: 14/854,692

(22) Filed: Sep. 15, 2015

Related U.S. Application Data
(60) Provisional application No. 62/050,559, filed on Sep. 15, 2014.

(51) Int. Cl. G06Q 30/06

(52) U.S. Cl. CPC G06Q 30/0627; G06Q 30/0643

(57) ABSTRACT

A user-friendly method for filtering LED products in order to identify a matching design ideal for a specific lighting application described by a user. The method includes first displaying a plurality of filter question, each associated with a plurality of answers. Next, a desired answer is received from a user account and is used to update an aggregate set of desired specifications with an at least one technical specification. The aggregate set of desired specifications is then compared against each of a plurality of LED designs in order to identify an at least one matching LED design. The aforementioned process is repeated as a plurality of iterations, with each iteration being associated with a filter question. Resultantly, the matching LED design of a last iteration is graphically displayed through a user computing device.

The current application claims a priority to the U.S. Provisional Patent application Ser. No. 62/050,559 filed on Sep. 15, 2014.

### FIELD OF THE INVENTION

The present invention relates generally to a method for a product selection engine in relation to light-emitting diode (LED) fixtures. More specifically, the present invention is a method for assisting consumers in identifying and selecting a proper LED design based on a set needs and preferences.

### BACKGROUND OF THE INVENTION

Today, there exists a need to help consumers, individuals and businesses, choose the correct light-emitting diode (LED) bulbs/lamps and LED fixtures for their needs. Buying LED bulbs/lamps and LED fixtures is a much harder task than purchasing traditional bulbs/lamps and traditional fixtures as have been commonplace since the invention of the first filament light bulb, by Thomas Edison in 1879. Traditional light products include halogen light bulbs, incandescent light bulbs, fluorescent light bulbs, compact fluorescent lamps, and metal-halide light bulbs.

In 1881, Lewis Howard Latimer improved upon Thomas Edison's findings by inventing a carbon filament. The following year, as part of Edison's research team known as “Edison's Pioneers”, Latimer developed and patented a method of manufacturing carbon filaments. It wasn't until 1910, when William David Coolidge invented a tungsten filament, which lasted longer than the older filaments. At that point in time, the incandescent bulb revolutionized the world. Due to an energy shortage caused by the 1973 oil crisis, engineers developed a fluorescent bulb that could be used in residential applications. In 1976, General Electric figured out how to bend the fluorescent tube into a spiral shape, creating the first compact fluorescent light (CFL). It wasn't until the mid 1980's when mass machinery was utilized in the mass production of CFL's.

While LED technology dates back to the 1970's with the use of indicator lights and calculators, it wasn't until the year 2000, when the Department of Energy (DOE) partnered with private industry to push LED technology forward by creating a high-efficiency device that packaged LED's together. In 2008, the DOE announced a competition to spur the development of ultra-efficient solid-state lighting products to replace common/traditional lighting technologies. Since then, there has been an onslaught of manufacturers, both in the United States and abroad that have flooded the marketplace with LED Bulbs and LED Fixtures that replace every conceivable traditional bulb/fixture that has existed in the marketplace for the previous 100 plus years. With the rush to market, manufacturing complexities of LED and myriad of choices, there has been much confusion for both the home and business consumer in terms of which LED light bulb, lamp or fixture is the right choice for them. As such, the market has been slow to adapt.

For example, in the past, if a consumer wanted to replace a halogen hi-hat bulb in their home or business, all they needed to know was the wattage and color choice of the bulb they were replacing. It didn't matter which manufactured bulb (hi-hat) they chose, because in the same category of bulbs/lamps (hi-hat in this case) all looked the same. With LED bulbs/lamps, that is simply not the case anymore. The landscape has changed. Today, customers might buy a handful LED Hi-Hats from different manufacturers that are advertised as the same wattage and color replacement. However, when they screw the various bulbs in at their home or place of business, it becomes abundantly clear that not all LED bulbs are equal. Every single bulb of the handful they try might have different color and light output characteristics.

Unlike traditional lighting of the past, LED bulbs create quite a bit of confusion. There are color variations as well as different wattages that don't necessarily equate to the lumen output of traditional bulbs. With that said, lumen outputs, even at the same wattage can vary greatly. Also, unlike traditional lighting, LED is a directional light. If you consider a traditional A19 incandescent bulb that is used in a wall sconce or table lamp with a shade covering, it is simply not enough to try and replace the incandescent bulb with an LED bulb that advertises the same wattage equivalence. The beam angle of the LED bulb must also be taken into consideration. With traditional lighting, a standard incandescent bulb will generally have light coverage ranging from 270 degrees to 360 degrees. With an LED A19 bulb/lamp, there are vast amounts of bulbs in the marketplace that fall well below 270 degrees beam angle. Usually, the LED customer is unaware until they screw the LED A19 into their shaded table lamp or wall sconce, only to find that the light coverage is not equal to the traditional bulb they are replacing. Furthermore, due to the lack of knowledge of those that are selling LED, many customers have to continually return and try new LED bulb/lamps, until they find one that works in their application. It is frustrating experiences such as this that have slowed the widespread growth of LED lighting in both home and business applications. There are websites in today's market that offer filtering options in hopes of helping the consumer narrow their choices in hopes of making a more informed buying decision when purchasing LED.

Unfortunately, these filtering systems are extremely confusing for the average home and business consumer. Most consumers can look at a picture of a traditional bulb and recognize that they currently use that bulb at their home or place of business. However, most consumers do not know the specific name of the type of bulb they are using. For example, customers are aware that they have hi-hat bulb/lamps but they are not aware that the technical term for that bulb/lamp type is “R or BR”. Customers are aware that they have fluorescent tubes but they are not aware that some are “T8” type tubes, while others are “T12”. Customers are aware that they might want to replace their “chandelier bulbs” but are not unaware that they are referred to as “decorative” or “candelabra” type bulbs. The point is that, while there are other solutions available to assist customers in selecting the right LED bulb/lamps for their home and/or businesses, the customer must have some working knowledge of bulbs to pinpoint the correct LED bulb/lamps for their needs. Unfortunately, the average consumer have little to no working knowledge of their needs and/or requirements when looking to replace their traditional lamp/bulbs and fixtures with an LED replacement.

### BRIEF DESCRIPTION OF THE DRAWINGS

FIG. 1 is a flowchart for the present invention depicting the overall process.

FIG. 2 is a flowchart of the present invention depicting the steps executed in order to utilize a plurality of design categories for the present invention, specifically in relation to a plurality of light-emitting diode (LED) designs.

FIG. 3 is a flowchart of the present invention depicting the steps executed in order to utilize a plurality of design categories for the present invention, specifically in relation to a plurality of filter questions.

FIG. 4 is a flowchart of the present invention depicting the use of location-based services.

FIG. 5 is a flowchart of the present invention depicting the steps required in order to display an aggregate set of desired specifications.

FIG. 6 is a flowchart of the present invention depicting an embodiment which continuously displays an at least one matching LED design for a specific iteration during the plurality of iterations.

FIG. 7 is a flowchart of the present invention implemented in a retail store through a store kiosk.

FIG. 8 is a schematic diagram of the present invention depicting the user computing device being implemented in the form of a store kiosk.

FIG. 9 is a schematic diagram of the present invention depicting the user computing device being utilized inside a retail store in conjunction with a physical visual indicator.

### DETAIL DESCRIPTIONS OF THE INVENTION

All illustrations of the drawings are for the purpose of describing selected versions of the present invention and are not intended to limit the scope of the present invention.

The present invention is a method for a product selection engine. More specifically, the present invention is a filtering method which assists a consumer in identifying and selecting the proper light-emitting diode (LED) product(s) for his or her specific lighting application needs. In particular, the present invention is aimed to aid the consumer in identifying the LED based products, LED bulbs and or LED fixtures, which fit the technical specification associated with an existing traditional light bulbs and fixtures which he or she owns. Traditional light bulbs and fixtures include, but are not limited to, halogen, incandescent, fluorescent, metal-halide, high pressure sodium, and other type of light or lighting fixture that can be replaced with an LED product.

The present invention is a method implemented in the form of a software application by a user computing device and an external server. The present invention is preferably integrated into a website that is hosted on the external server and is accessible through the Internet. The external server provides the significant amounts of data storage to be used by the present invention. A user may access the website and, therefore, the present invention through the user computing device. The user computing device may be virtually any modern computing device which possesses an Internet connection and a user interface. The user computing device can be, but is not limited to, desktops, laptops, tablet computers, Internet-enabled mobile phone, smart phones, and other portable computing devices.

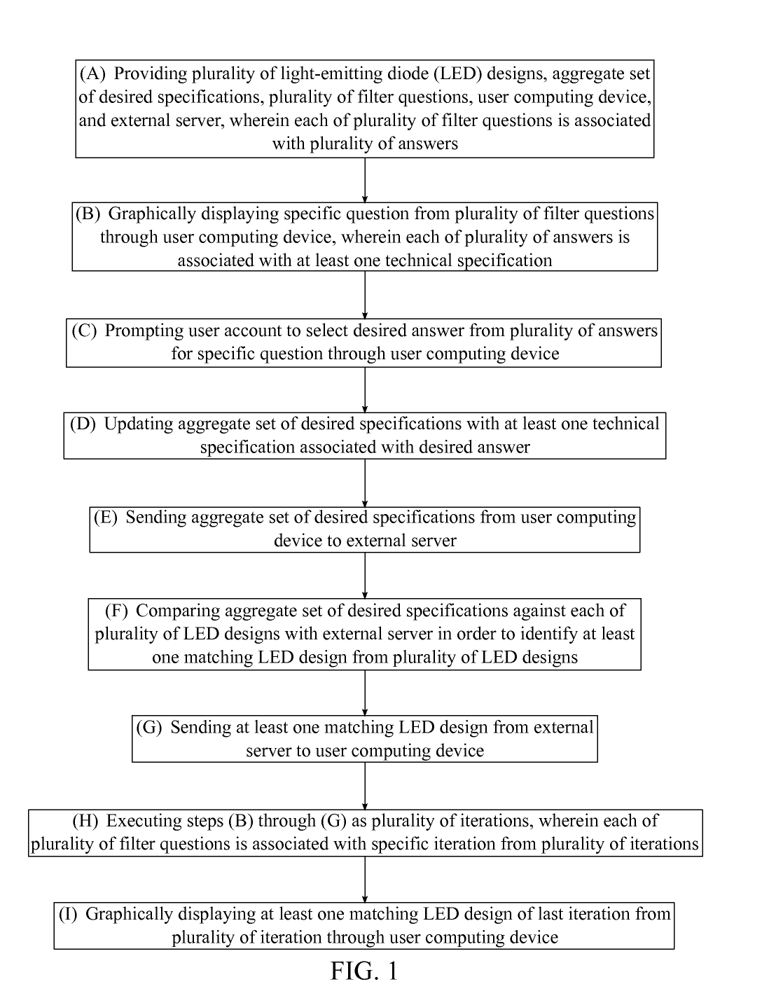

Referring to FIG. 1, the overall process of the present invention delineates the steps necessary to be taken in order to identify a correct LED design for a particular lighting application for a user, referred to as a user account. The initial step of the overall process includes populating the external server with a plurality of LED designs, a plurality of filtering questions, and an aggregate set of desired specifications (Step A).

The plurality of LED designs is a list of LED products and their respective designs, uses, and respective fields that are available on the market. Each of the plurality of filtering questions is preferably a simple “laymen term” question corresponding to a particular aspect/metric of a lighting application, such as wattage, light color, and illumination degree to name a few non-limiting example. In order to facilitate a more user friendly experience, each of the plurality of filter questions is associated with a plurality of answers, essentially multiple choice questions. Each of the plurality answers is further associated with an at least one technical specification in relation to LED designs from the plurality of LED designs. Through this association, the present invention is able to determine the exact needs of the user account. The aggregate set of desired specifications is a list of metrics defining the needs of the user.

Next in the overall processes for the present invention is graphically displaying a specific question from the plurality of filter questions through the user computing device, which also includes displaying the associated plurality of answers (Step B). The specific question may be displayed in conjunction with images, texts, videos, and other forms of media that are related to the question. The user account is then prompted to select a desired answer from the plurality of answers for the specific question through the user computing device (Step C). The user may select the desired answer by clicking a corresponding box or entering text which correspond to the desired answer. Upon receiving the desired answer for the specific question, the present invention updates the aggregate set of desired specifications with the at least one technical specification associated with the desired answer (Step D). The aggregate set of desired specifications directly reflects the needs and wants of the user based on the desired answer. Next, the aggregate set of desired specifications is then sent from the user computing device to the external server as search query (Step E). The external server compares the aggregate set of desired specifications against each of the plurality of LED designs in order to identify an at least one matching LED design from the plurality of LED designs (Step F). The at least one matching LED design meets the requirements set by the search query, the aggregate set of desired specifications. The identified at least one matching LED design is then sent back to the user computing device from the external server (Step G). The aforementioned steps, in particular steps (B) through (G), are executed as a plurality of iterations for each of the plurality of filter questions; each of the plurality of filter question is associated with a specific iteration from the plurality of iterations (Step H). The plurality of iterations is executed until each of the filter questions is answered. Additionally, the aggregate set of desired specifications is continuously updated during the plurality of iterations. Once each of the filter question has been answered, the user computing device graphically displays the at least one matching LED design of a last iteration from the plurality of iterations (Step I). The last iteration is associated with the most updated aggregate set of desired specifications and fully reflects the needs and requirements of the user.

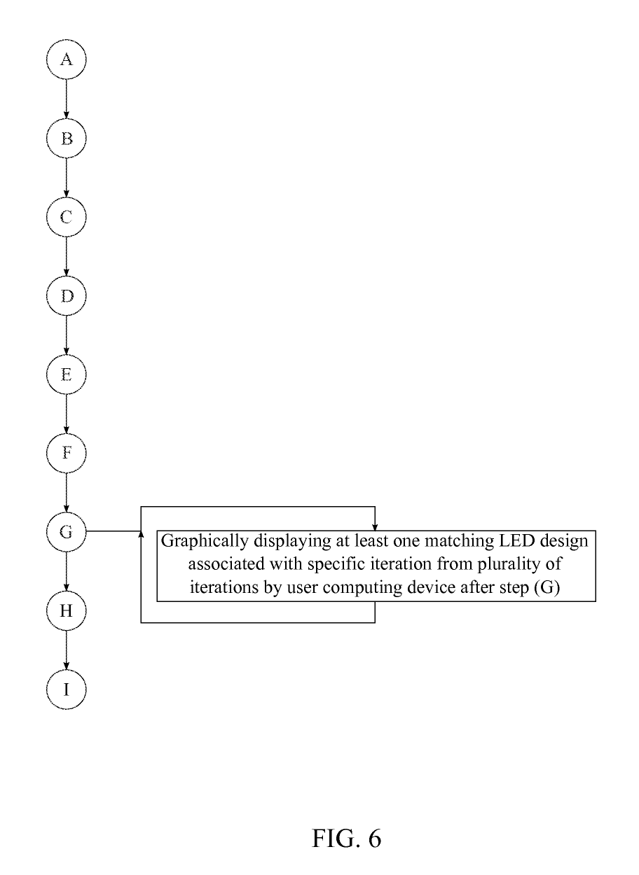

In the preferred embodiment, the present invention executes the plurality of iterations and then displays the at least one matching LED design which matches all of the specifications within the aggregate set of technical specifications. This requires the user to answer all of the questions within the plurality of filter questions before receiving any results. In an alternative embodiment, the present invention continuously displays the at least one matching LED design for each of the plurality of iterations as each question is answered as seen in FIG. 6. More specifically, the at least on matching LED design associated with the specific iteration from the plurality of iterations is graphically displayed after step (G) by the user computing device. As the user answers more questions, the resulting matching LED designs are further filtered and displayed to reflect the aggregate set of technical specifications as indicated by the answers. In this regard, the user may be able find the LED design for which they are looking before completing all of the questions from the plurality of filtering questions.

Each of the plurality of filter questions is designed to be simple, multiple choice, to facilitate a quicker and easier process. Questions may be displayed by the user computing device through text and may include corresponding images, videos, or animations to further aid the user in his or her selection of an answer. Questions may require only one answer while others may allow more than one answer. Additionally, certain questions may be required to be answered by the user while others may give the user the option to provide a “not sure” answer or skip the question entirely. An example of a question from the plurality of filter questions is “What is the approximate width of the bulb you are replacing?” with the following as the plurality of answers “a. Close to 5 inches b. Close to 4 inches c. Close to 3 inches”. The selected answer to this first question is associated with the technical specification relating to the type of “hi-hat” he or she currently owns. More specifically, the answer (a) refers to a BR40 “hi-hat”, answer (b) refers to a BR30 “hi-hat”, and answer (c) refers to a BR20 “hi-hat”.

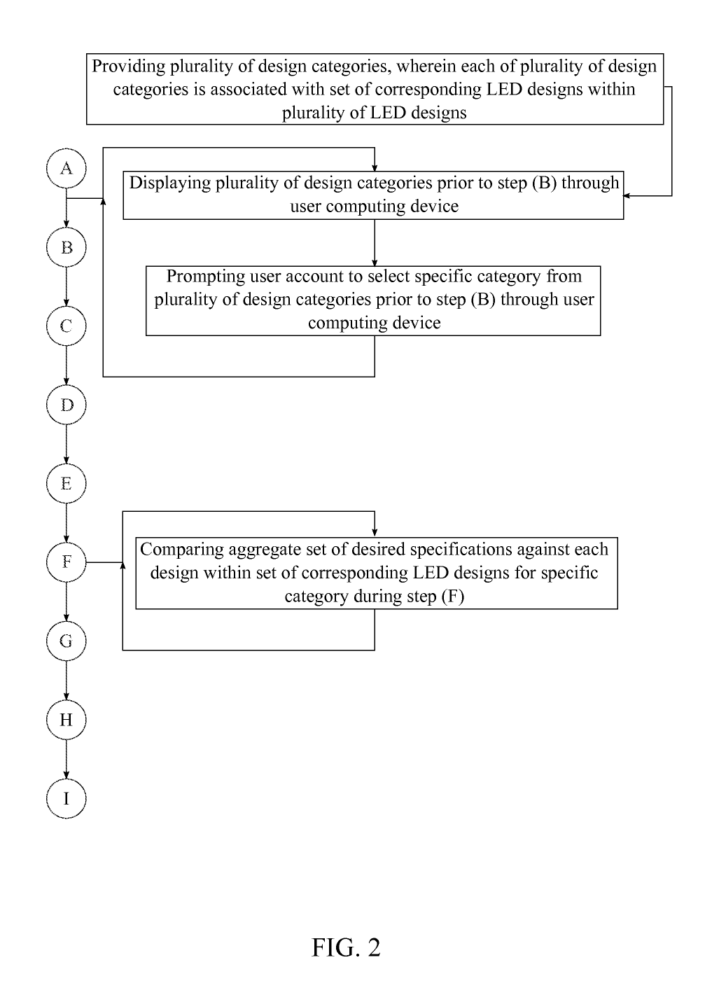

Referring to FIG. 2, in one embodiment, the present invention also subdivides the plurality of LED designs into various groups in order to facilitate a more efficient means for identifying the at least one matching LED design. More specifically, the present invention utilizes a plurality of design categories to group the plurality of LED designs with each of the plurality of design categories being associated with a set of corresponding LED designs within the plurality of LED designs. Categories includes, but are not limited to, lamp bulbs, candelabra bulbs, compact fluorescent lamps, Christmas lights, dimmers, fluorescent tubes, globe bulbs, multifaceted reflector bulbs, landscape lighting, pool lighting, R or BR bulbs, recessed downlights, and safety lighting. The category selection is executed prior to step (B). In particular, first the plurality of categories is graphically displayed through the user computing device. Then the user account is prompted to select a specific category from the plurality of design categories through the user computing device. The plurality of design categories may be arranged in any order, the preferred arrangement is alphabetical order. Additionally, the plurality of design categories may be displayed through a variety of means including, but not limited to, text, images, videos, and animations in order to aid in identifying the type of light product the user may need or is searching for. The selection of the specific category from the plurality of design categories places a limitation on which designs from the plurality of LED designs that are viewed and compared against during step (F). In particular, the aggregate set of desired specifications is compared against each design within the set of corresponding LED designs for the specific category. For example, a user may wish to replace a traditional light bulb in the kitchen of his or her home, the present invention would exclude any LED designs/products from the search that are not typically used in home applications.

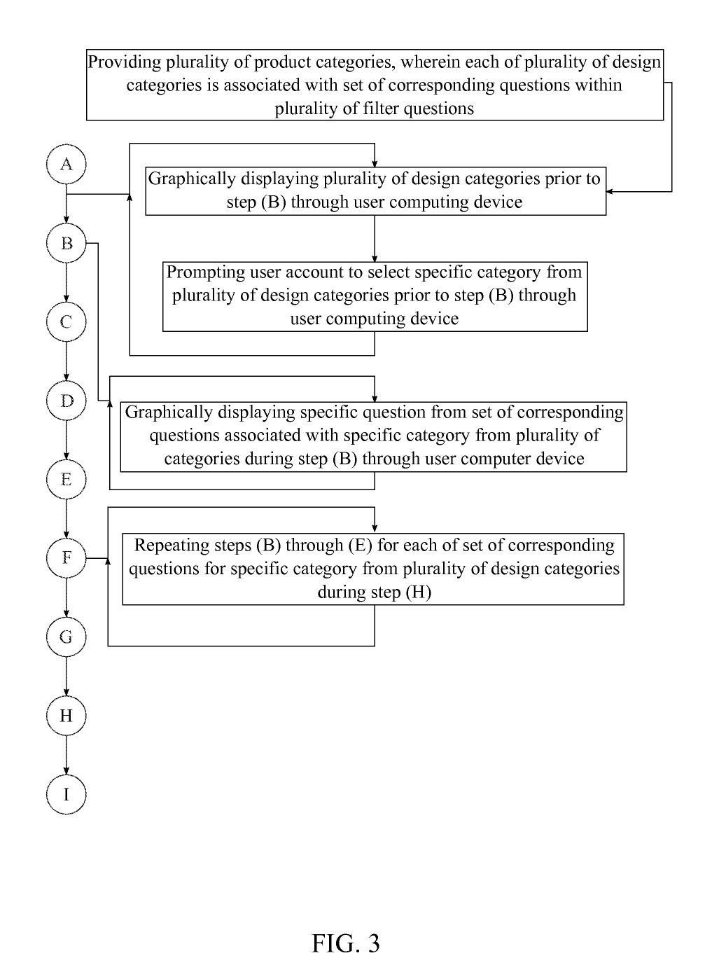

Referring to FIG. 3, in addition to subdividing the plurality of LED designs, the plurality of design categories also subdivides the plurality of filter questions. In particular, each of the plurality of design categories is associated with a set of corresponding questions within the plurality of filter questions. The selection of the specific category from the plurality of design categories limits which questions are used throughout the overall process of the present invention. This tailors the overall process to the set of corresponding LED designs for the specific category, ensuring the user does not need to answer unrelated and unnecessary questions in relation to his or her specific lighting application. During the step (B), the user computing device graphically displays a specific question only from the set of corresponding questions associated with the specific category. Similarly, the overall process is repeated only for the set of corresponding questions for the specific category as seen in FIG. $. In particular, steps (B) through (E) are repeated for each of the set of corresponding questions for the specific category from the plurality of design categories during step (H).

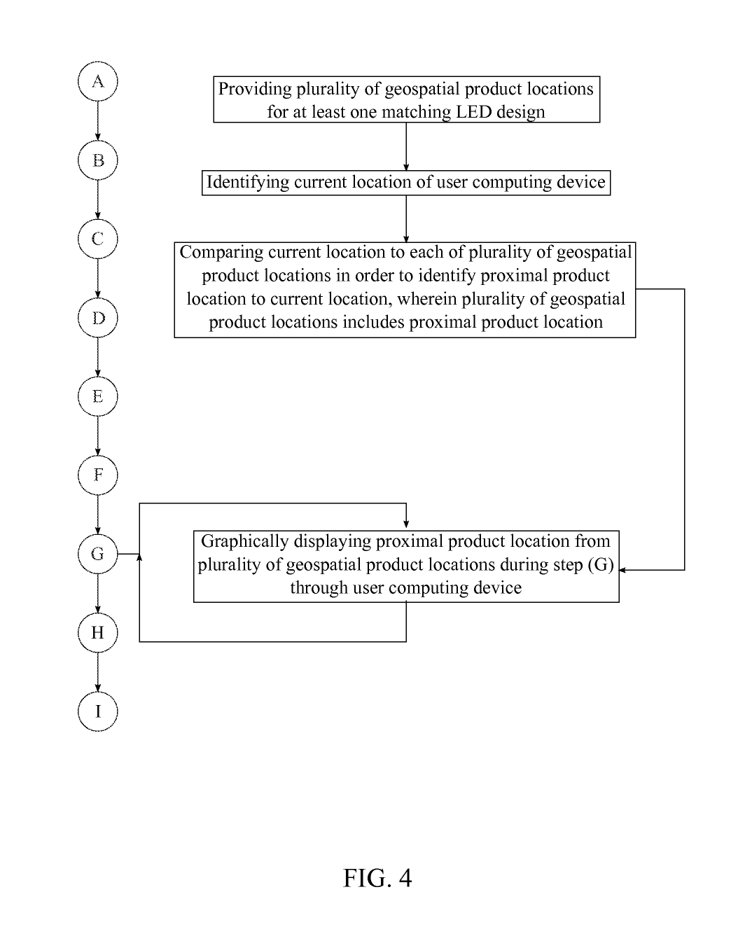

Referring to FIG. 4, in one embodiment, the present invention utilizes location-based services in order to locate and display nearby product locations for the at least one matching LED design. For this feature, the present invention is provided with product locations for each of the plurality of LED designs. This information may be obtained through a variety of means. The preferred method includes the external server and or the user computing device being directly connected to inventories and product databases of large-scale retailers of LED products as well as electrical distributors such as Home Depot, Lowe's, Menard's, Orchard Supply Hardware, Handy Andy Home Improvement Center, Hechinger, Sears, Ernst Home Centers, Empire Today, Channel Home Centers, Builder's Square, Build.com, 84 Lumber, Home Quarter's Warehouse, Home Base, Home Fix Corporation, Pacific Sales, Pay'n Pak, Payless Cashways, Proteak, Rickel, Scotty's Builder's Supply & Valu Home Centers, Grainger, Graybar, HD Supply, and CED.

In order to identify nearby products, the present invention first identifies a current location of the user computing device, and therefore the user. This may be achieved through a variety of means. In one embodiment of the present invention, the user computing device contains a global positioning system (GPS) which reports the current location. In alternative embodiments, various types of location systems are utilized such as cell tower triangulation methods. Then the present invention identifies a plurality of geospatial product locations for the at least one matching LED design. Next, the current location is compared to each of the plurality of geospatial locations for the at least one matching LED design in order to identify an at least one proximal product location to the current location of the user computing device; the at least one proximal product location is one of the plurality of geospatial product locations. The distance value for identifying the at least one proximal product location may be pre-set by an administrative entity. Alternatively, the distance value may be entered by the user account, thus providing an additional layer of customization to the feature. If the at least one proximal product location is identified, then it is graphically displayed during step (G) through the user computing device. The at least one proximal product location may be displayed in the form of an address, a retail location, a map image, or a combination thereof.

The location-based services may be further categorized into the inventories of proximal store locations. To this end, location information obtained by from the user computing device sets which inventories the present invention searches. If the user computing device reports the current location to be within a Home Depot retail store, then the present invention only searches through the inventories of said retail store. If the user computing device is in close proximity to more than one retail store, then the present invention prompts the user to choose at which retail store he or she is currently located.

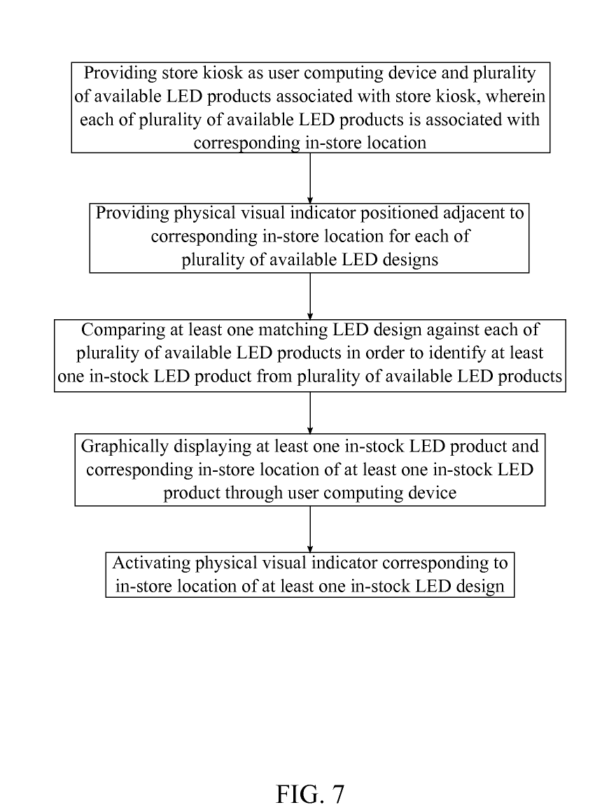

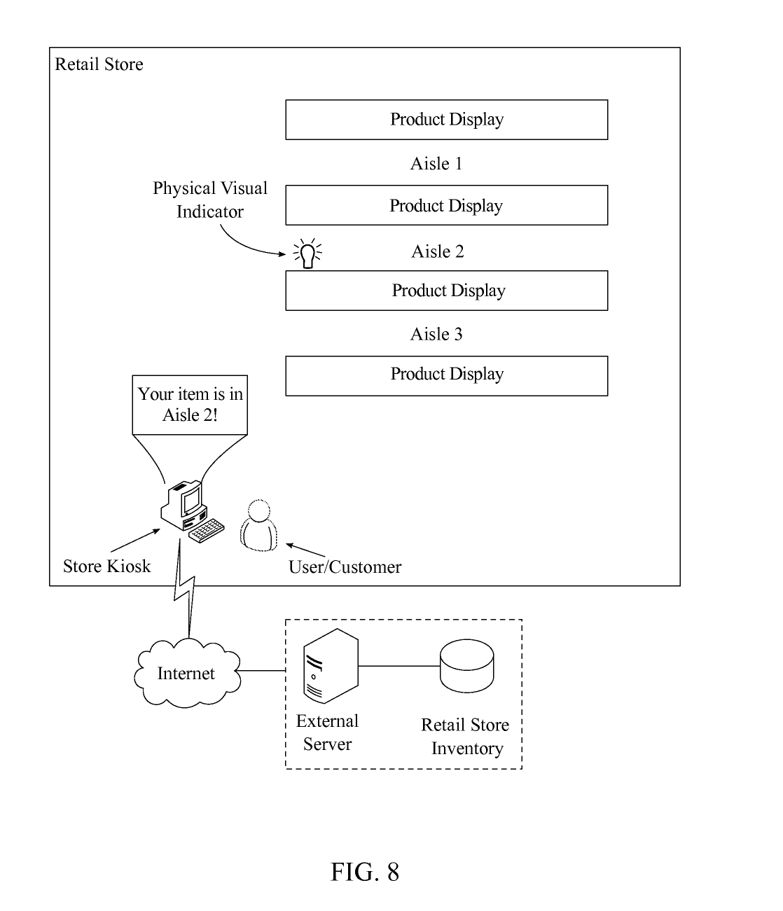

Referring to FIG. 7 and FIG. 8, in yet another embodiment, the present invention is implemented directly in a retail store through a store kiosk. In this embodiment, the user computing device is the store kiosk. The store kiosk is provided with and associated with a plurality of available LED products, the retail store's inventory. Each of the plurality of LED products is additionally associated with a corresponding in-store location, this information is provided and continuously updated by an administrator entity, the retail store. In-store location includes information relating to specific aisles, sections, and store levels to name a few non-limiting examples. Once the at least one matching LED design is identified, the present invention then compares the at least one matching LED design against each of the plurality of available LED products in order to identify an at least one in-stock LED product from the plurality of available LED products. If an at least one in-stock LED product is identified, then it is graphically displayed through the store kiosk along-side with the corresponding in-store location as seen in FIG. 8. To further aid the user in locating the at least on in-stock LED product, a physical visual indicator is positioned adjacent to the corresponding in-store location for each of the plurality of available LED designs. The preferred physical visual indicator is a pair of flashing diodes. Once the at least one in-stock LED product is displayed to the user, the present invention activates the physical visual indicator corresponding to the in-store location of the at least one in-stock LED in order to further assist the user in locating the in-stock LED product. An example is seen in FIG. 8 where the at least one in-stock LED product is located in the second aisle; this information is first displayed to the user and then the physical visual indicator that is associated with the second aisle is activated in order to signal to the user.

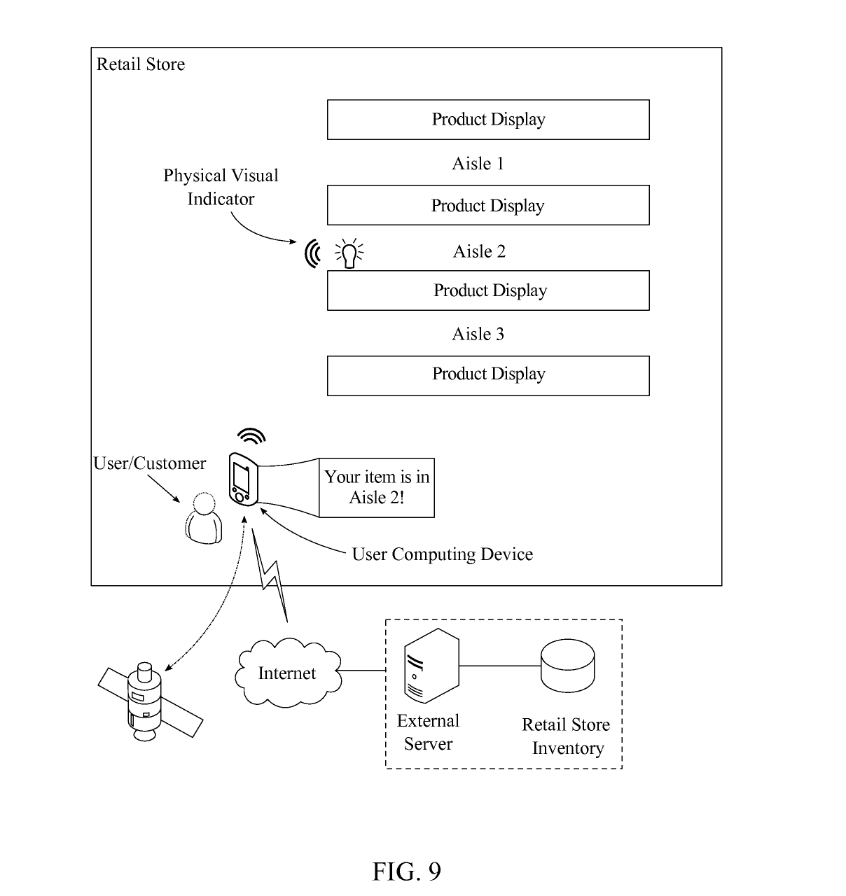

In an alternative embodiment, the physical visual indicator is communicably coupled to the user computing device in order to respond when the user computing device is within a certain vicinity of the physical visual indicator. This is achieved through near-field communication tags or other location-responsive devices such as GPS. An example is seen in FIG. 9 where the physical visual indicator wirelessly communicates with the user computing device and turns on when the user computing device approaches the second aisle. The distance required for the physical visual indicator to activate may vary and in one embodiment may be set by the user.

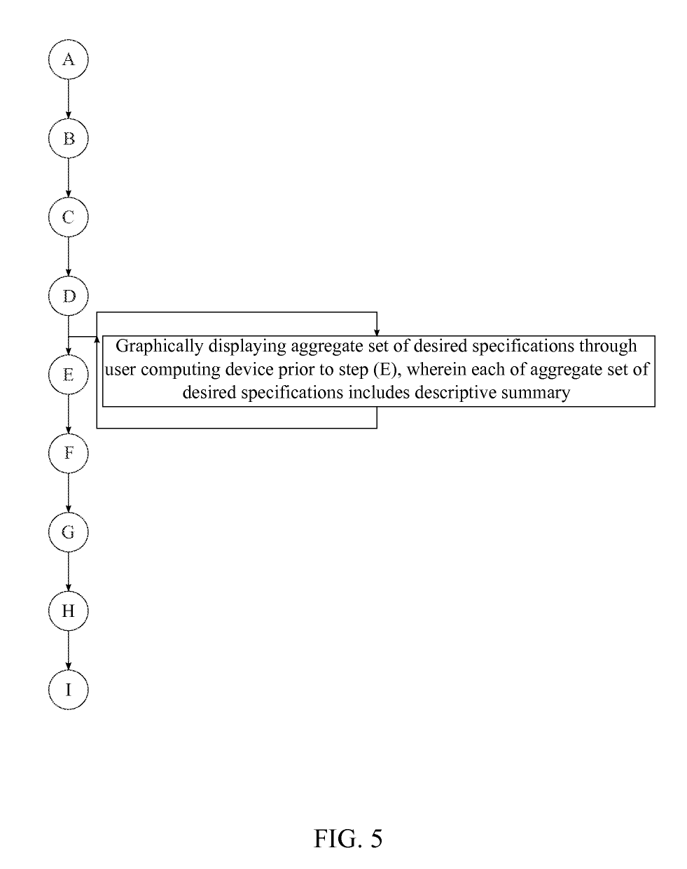

In one embodiment, the present invention also provides the user with educational information about relevant LED products. More specifically, the user computing device graphically displays the aggregate set of desired specifications prior to step (E) wherein each of the aggregate set of desired specifications includes a descriptive summary as seen in FIG. 5. The descriptive summary may include definitions, diagrams, videos, pictures, and other similar information which further describes the corresponding technical specification. For example, for the wattage specification the descriptive summary will include the intensity and the yearly power consumption ratings for various wattage ratings.

An additional example of a question from the plurality of filter questions is “What color choice do you prefer?” with the following as the plurality of answers:

a. Very Yellow (mustard yellow . . . almost to the point of being orange)

b. Yellow (I like yellow, without appearing too white)

c. Soft White (I like soft white, with maybe a tinge of yellow)

d. Natural White (I like a nice white without being too white)

e. Stark White (I like white that is a stark white)

The selected answer to this question is associated with the technical specification relating to the temperature associated with an LED design. More specifically, the answer (a) refers to 2500 K (Kelvin), answer (b) refers to 2700 K, answer (c) refers to 3000 K, answer (d) refers to 4000 K, and answer (e) refers 5000 K.

Another example of a question from the plurality of filter question is “Where will these bulbs be used?” with the following as the plurality of answers:

a. Indoor (Hi-Hats in the Kitchen, Living Room, etc.)

b. Outdoor (in Covered Fixture for Landscape, Security, etc.)

c. Outdoor (Exposed to the Elements for Landscape, Security, etc.)

The selected answer to this question is associated with the technical specification relating to the rating associated with various environments. More specifically, the answer (a) refers to indoor rating, answer (b) refers to outdoor/damp location rating, and answer (c) refers to waterproof rating.

Another example of a question from the plurality of filter question is “Approximately how high are the ceilings (indoors) or the throw distance (outdoors), where these bulbs will be used?” with the following as the plurality of answers:

a. 4 ft.

b. 5 ft.

c. 6 ft.

d. −k . . . to 14 ft.

The selected answer to this question is associated with the technical specification relating to the correct lumen output needed.

Another example of a question from the plurality of filter question is “When it comes to light . . . ?” with the following as the plurality of answers:

a. I like a muted amount of light

b. I like a normal amount of light

c. I like a lot of light

The selected answer to this question is associated with the technical specification relating the intensity and degree of coverage of an LED design.

Another example of a question from the plurality of filter question is “Do you need bulbs that are dimmable?” with the following as the plurality of answers:

a. Yes

b. No

The selected answer to this question determines if the LED design is dimmable or not.

Although the invention has been explained in relation to its preferred embodiment, it is to be understood that many other possible modifications and variations can be made without departing from the spirit and scope of the invention as hereinafter claimed.

What is claimed is:

1. A method for an LED product filtering engine by executing computer-executable instructions stored on a non-transitory computer-readable medium, the method comprises the steps of:
(A) providing a plurality of light-emitting diode (LED) designs, an aggregate set of desired specifications, a plurality of filter questions, a user computing device, and an external server, wherein each of the plurality of filter questions is associated with a plurality of answers;
(B) graphically displaying a specific question from the plurality of filter questions through the user computing device, wherein each of the plurality of answers is associated with an at least one technical specification;
(C) prompting a user account to select a desired answer from the plurality of answers for the specific question through the user computing device;
(D) updating the aggregate set of desired specifications with the at least one technical specification associated with the desired answer;
(E) sending the aggregate set of desired specifications from the user computing device to the external server;
(F) comparing the aggregate set of desired specifications against each of the plurality of LED designs with the external server in order to identify an at least one matching LED design from the plurality of LED designs;
(G) sending the at least one matching LED design from the external server to the user computing device;
(H) executing steps (B) through (G) as a plurality of iterations, wherein each of the plurality of filter questions is associated with a specific iteration from the plurality of iterations; and
(I) graphically displaying the at least one matching LED design of a last iteration from the plurality of iteration through the user computing device.

2. The method for an LED product filtering engine by executing computer-executable instructions stored on a non-transitory computer-readable medium, the method as claimed in 1 comprises the steps of:
graphically displaying the at least one matching LED design associated with the specific iteration from the plurality of iterations by the user computing device after step (G).

3. The method for an LED product filtering engine by executing computer-executable instructions stored on a non-transitory computer-readable medium, the method as claimed in 1 comprises the steps of:
providing a plurality of design categories, wherein each of the plurality of design categories is associated with a set of corresponding LED designs within the plurality of LED designs;
displaying the plurality of design categories prior to step (B) through the user computing device;
prompting the user account to select a specific category from the plurality of design categories prior to step (B) through the user computing device; and
comparing the aggregate set of desired specifications against each design within the set of corresponding LED designs for the specific category during step (F).

4. The method for an LED product filtering engine by executing computer-executable instructions stored on a non-transitory computer-readable medium, the method as claimed in 1 comprises the steps of:
providing a plurality of product categories, wherein each of the plurality of design categories is associated with a set of corresponding questions within the plurality of filter questions;
graphically displaying the plurality of design categories prior to step (B) through the user computing device;
prompting the user account to select a specific category from the plurality of design categories prior to step (B) through the user computing device;
graphically displaying a specific question from the set of corresponding questions associated with the specific category from the plurality of categories during step (B) through the user computer device; and
repeating steps (B) through (E) for each of the set of corresponding questions for the specific category from the plurality of design categories during step (H).

5. The method for an LED product filtering engine by executing computer-executable instructions stored on a non-transitory computer-readable medium, the method as claimed in 1 comprises the steps of:
providing a plurality of geospatial product locations for the at least one matching LED design;
identifying a current location of the user computing device;
comparing the current location to each of the plurality of geospatial product locations in order to identify an at least one proximal product location to the current location, wherein the plurality of geospatial product locations includes the at least one proximal product location; and
graphically displaying the at least one proximal product location from the plurality of geospatial product locations during step (G) through the user computing device.

6. The method for an LED product filtering engine by executing computer-executable instructions stored on a non-transitory computer-readable medium, the method as claimed in 1 comprises the steps of:
providing a store kiosk as the user computing device and a plurality of available LED products associated with the store kiosk, wherein each of the plurality of available LED products is associated with a corresponding in-store location;
comparing the at least one matching LED design against each of the plurality of available LED products in order to identify an at least one in-stock LED product from the plurality of available LED products; and
graphically displaying the at least one in-stock LED product and the corresponding in-store location of the at least one in-stock LED product through the user computing device.

7. The method for an LED product filtering engine by executing computer-executable instructions stored on a non-transitory computer-readable medium, the method as claimed in 6 comprises the steps of:
providing a physical visual indicator positioned adjacent to the corresponding in-store location for each of the plurality of available LED designs; and
activating the physical visual indicator corresponding to the in-store location of the at least one in-stock LED design.

8. The method for an LED product filtering engine by executing computer-executable instructions stored on a non-transitory computer-readable medium, the method as claimed in 1 comprises the steps of:
graphically displaying the aggregate set of desired specifications through the user computing device prior to step (E), wherein each of the aggregate set of desired specifications includes a descriptive summary.
